(19) United States
(12) Patent Application Publication
(10) Pub. No.: US 2016/0065503 A1
(43) Pub. Date: Mar. 3, 2016

(54) METHODS, SYSTEMS, AND COMPUTER READABLE MEDIA FOR VIRTUAL FABRIC ROUTING

(71) Applicant: Extreme Networks, Inc., San Jose, CA (US)

(72) Inventors: Kevin M. Yohe, Manchester, NH (US); Brendan J. Fee, Nashua, NH (US); Stephen Henry Negus, Windham, NH (US)

(21) Appl. No.: 14/710,533

(22) Filed: May 12, 2015

Related U.S. Application Data
(60) Provisional application No. 62/044,161, filed on Aug. 29, 2014.

(51) Int. Cl. H04L 12/931; H04L 12/707; H04L 29/08

(52) U.S. Cl. CPC H04L 49/70; H04L 69/321; H04L 45/22

(57) ABSTRACT

The subject matter described herein includes methods, systems, and computer readable media for virtual fabric routing. One system includes a virtual fabric routing (VFR) service router agent for providing access to layer 3 routing. The system further includes at least one VFR proxy forwarder device, for performing layer 3 routing for packets traversing virtual local area networks (VLANs) within a virtual fabric routing domain and for forwarding, to a an address provided by the VFR service router agent, packets for which a layer 3 address resolution fails.

### PRIORITY CLAIM

This application claims the benefit of U.S. Provisional Patent Application Ser. No. 62/044,161, filed Aug. 29, 2014, the disclosure of which is incorporated herein by reference in its entirety.

### TECHNICAL FIELD

The subject matter described herein relates to performing layer 3 routing using topology information derived from layer 2.

### BACKGROUND

In a layer 2 topology domain, such as a shortest path bridging (SPB) or spanning tree protocol (STP) domain, layer 2 nodes perform layer 2 packet forwarding to directly connected devices. In order to perform layer 3 routing in such a network, the layer 2 nodes forward packets to a layer 3 router, which typically routes packets between VLANs. As a result, a packet must traverse the layer 2 topology domain to the layer 3 router, from the layer 3 router back through the layer 2 topology domain, and to the destination. Such double traversal of the layer 2 network is undesirable as it increases the time required to forward each packet. In addition, a router redundancy protocol may be run on the layer 3 routers to provide redundancy for hosts and servers in the network. In a network supporting tens of thousands of users over thousands of VLANs, running a router redundancy protocol on potentially all of the VLANs can be debilitating and reduce network performance as well as increase CPU utilization on routers running the protocol.

Accordingly, there exists a need for improved methods, systems, and computer readable media for virtual fabric routing.

### SUMMARY

The subject matter described herein includes methods, systems, and computer readable media for virtual fabric routing. One system includes at least one virtual fabric routing (VFR) service router agent for providing access to layer 3 routing. The system further includes at least one VFR proxy forwarder device, for performing layer 3 routing for packets traversing virtual local area networks (VLANs) within a virtual fabric routing domain and for forwarding, to an address provided by the at least one VFR service router agent, packets for which a layer 3 address resolution fails.

As used herein, the term “VFR domain” refers to all or a subset of VFR proxy forwarder devices and associated service routers that perform virtual fabric routing as described herein. Nodes within a VFR domain may participate in a layer 2 topology discovery protocol to learn about other nodes in the domain.

The subject matter described herein can be implemented using a non-transitory computer readable medium having stored thereon executable instructions that when executed by the processor of a computer control the computer to perform steps. Exemplary computer readable media for implementing the subject matter described herein may include chip memory devices, disk memory devices, programmable logical devices, and application specific integrated circuits. In addition, a computer readable medium that implements the subject matter described herein may be located on a single device or computing platform or may be distributed across plural devices or computing platforms.

### BRIEF DESCRIPTION OF THE DRAWINGS

Preferred embodiments of the subject matter described herein will now be described with reference to the accompanying drawings of which:

FIG. 1 is a network diagram illustrating a conventional routing model according to an embodiment of the subject matter described herein;

FIG. 2 is a network diagram illustrating a system for virtual fabric routing according to an embodiment of the subject matter described herein;

FIG. 3 is a block diagram illustrating an exemplary architecture for a VFR proxy forwarder device according to an embodiment of the subject matter described herein;

FIG. 4 is a block diagram illustrating an exemplary architecture for a service router that interacts with VFR proxy forwarder devices according to an embodiment of the subject matter described herein;

FIG. 5 is a flow chart illustrating an exemplary process virtual fabric routing according to an embodiment of the subject matter described herein; and

FIGS. 6A-6D illustrate different routing methods over a shortest path bridging network and associated link costs.

### DETAILED DESCRIPTION

### Overview

Virtual Fabric Routing—The subject matter described herein provides highly scalable and efficient virtualized layer 3 routing over any layer 2 network infrastructure. The fabric can scale from a single chassis to a large collection of devices that use any layer 2 protocol to form its topology. The layer 2 topology protocol can be one that forms a single path, like spanning tree or a multipath service like Shortest Path Bridging (SPB). In one implementation of the subject matter described herein, a layer 2 service proliferates all VLANs to the packet forwarding devices, referred to as VFR proxy forwarders, within the VFR domain. One aspect of the subject matter described herein is to offer a routing solution that most efficiently utilizes the layer 2 infrastructure by leveraging its topology protocols in place of layer 3 topology protocols. Of interest are those layer 2 services that support multiple egress paths, have knowledge of all VLANS, and allow hosts to freely move throughout a layer 2 domain. Virtual fabric routing supports the establishment of a network-wide, distributed virtual routing system where all of the devices in the system work as a single and collective layer 3 forwarding mechanism. In such an implementation, routing becomes an integrated service of the layer 2 domain and packet forwarding from source to final destination is more optimized.

For example, Shortest Path Bridging or SPB is a layer 2 technology defined by IEEE 802 that augments the IEEE 802 spanning tree protocol to utilize multiple paths and defines SPBV, a type of SPB, to service multiple VLANs. In an SPBV network, routers attach at the edge of the SPBV network to forward traffic between customer VLANS. The routers at the edge of the network receive IP packets from the nodes in the network, route the packets, determine the appropriate VLANs for the packets, and forward the packets back into the layer 2 network on different VLANS. The packet forwarding nodes within the layer 2 network do not have any layer 3 routing capabilities. Because the router receives packets and forwards the packets back into the same layer 2 network, the router is often referred to as a “one-armed router”. Although this one-armed routing function is workable, it does not provide the most direct path through the network.

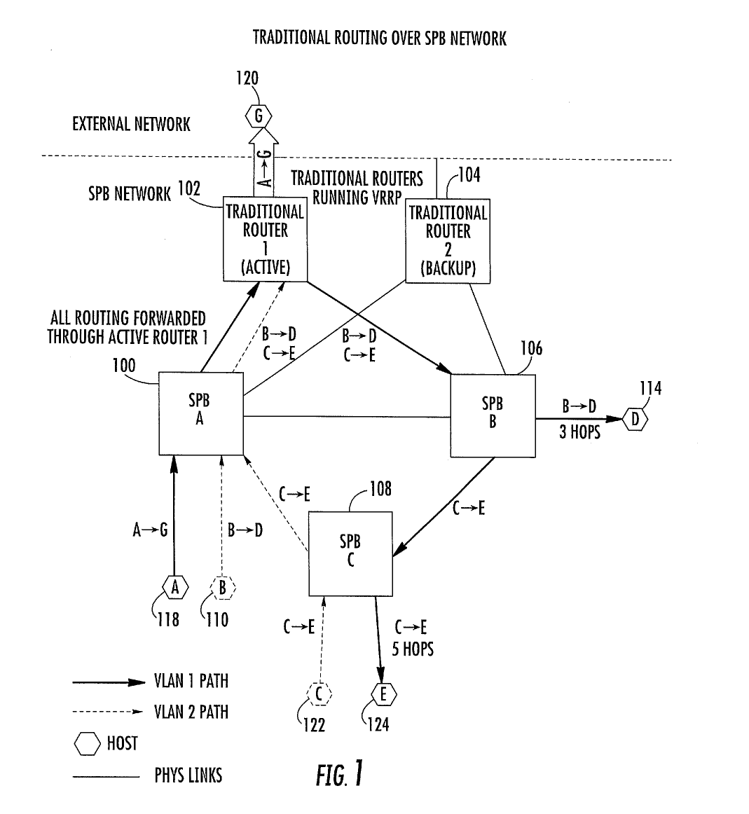

As shown in FIG. 1, routed packets egress the layer 2 network from SPB node A 100 on one VLAN to a connecting router (traditional router X 102) which forwards the packets onto another VLAN within the same layer 2 network thereby traversing the layer 2 network twice. Furthermore, router 102 and a second router 104 may run Virtual Routing Redundancy Protocol (VRRP) on each VLAN interface to support redundancy for client hosts. VRRP advertisements consume network bandwidth and CPU resources of participating routers especially when scaled to hundreds or even thousands of VLANS.

In FIG. 1, nodes 100, 106, and 108 form a layer 2 forwarding domain. Each node 100, 106, and 108 runs SPB or SPBV to support multiple VLANs. As stated above, when one of nodes 100, 106, or 108 receives a packet that requires routing, the packet is forwarded to one of traditional routers 102 and 104, which performs layer 3 route lookups and forwards the routed packets back into the layer 2 network on VLANs that are different from those used by the received packets. Layer 2 nodes 100, 106, and 108 then deliver the packets to their layer 2 destinations (hosts) using layer 2 forwarding. For example, in FIG. 1, packets from host B 110 on VLAN2 may be layer 3 addressed to host D 114. For such packets, host B 110 sends the packets to SPB node A 100, which layer 2 switches (forwards) the packets to layer 3 router 102 on the same VLAN, VLAN 1. Layer 3 router 102 performs a layer 3 address lookup and forwards the packets on a different VLAN (VLAN 2) associated with destination D 114. SPB node B 106 layer 2 switches the packets to destination D on VLAN 116. Thus, the packets originating from host B 110 traverse the layer 2 network twice to get to the destination D 114.

A similar routing scenario occurs for packets originating from host A 118. In the example illustrated in FIG. 1, packets originating from host A 118 that are layer 3 addressed to destination G 120 leave host A on VLAN 1. SPB node 100 receives the packets and layer 2 forwards the packets to router 102 on the same VLAN, VLAN 1. Router 102 performs layer 3 address lookups for the packets and forwards the packets to destination G 120 on a different VLAN. In this case, the packets do not traverse the layer 2 network twice, but all packets requiring routing go through layer 3 router 102, which could be a bottleneck for packets leaving the layer 2 network.

Thus, in FIG. 1, when host B 110 sends packets to host D 114, the path to host D 114 must traverse through a traditional router (traditional router X 102 or traditional router Y 104), resulting in 3 hops for each packet.

The path from host C 122 to host E 124 is even less efficient than the previous examples. In FIG. 1, packets leaving host E 124 go to SPB C 108 on VLAN 2. SPB C 108 cannot resolve the IP address in the packets, so SPB C 108 layer 2 switches the packets to SPB A 100. SPB A 100 likewise cannot resolve the layer 3 or IP address in the packets, so SPB A 100 layer 2 switches the packets to traditional router 102. Traditional router 102 resolves the layer 3 address in the packets and forwards the packets on VLAN 1 to SPB B 106. SPB B 106 forwards the packets to SPB C 108 on VLAN 1. SPB C 108 forwards the packets to host E 124. Thus, packets from C to E go through 5 hops from source to destination, even though hosts C and E are locally connected to the same SPB node 108.

In addition to the routing inefficiencies illustrated in FIG. 1, VRRP may be run by routers 102 and 104 on each VLAN. With networks supporting tens of thousands of users over thousands of VLANs, running VRRP potentially on all VLANs can be debilitating and reduce network performance as well as increase CPU utilization on routers running the VRRP protocol. The subject matter described herein for virtual fabric routing routes packets directly to destinations and does not require the VRRP protocol to support router redundancy.

VFR provides an integrated routing service in that VFR proxy forwarders have layer 3 routing capabilities for directly connected nodes. VFR leverages layer 2 features, such as VLAN propagation, multipath topology, fast convergence, and MAC reachability to provide a simpler and efficient routing service that eliminates or reduces the need for routing protocols. By eliminating or reducing the need for routing protocols, the subject matter described herein can scale to support routing across the thousands of VLAN interfaces that may be present in a complex L2 domain. The elimination of or reduced need for L3 routing protocols also eliminates or reduces the need for interactions which occur between L2 topology changes and L3 topology changes.

Virtual fabric routing operates on the principle that hosts within a layer 2 domain are at most one routed hop away from other hosts. Assuming all VLAN interfaces are on every edge device, VFR proxy forwarders can route directly to their destinations using layer 2 services to perform the multipath and MAC reachability. Only when a VFR proxy forwarder cannot route must it forward to a border or service router that can. In a sense this method distributes limited routing throughout the SPB domain leaving full IP forwarding on a few selected service routers for packets which exit the VFR domain.

The term “service router” as used herein, refers to a device that includes both layer 3 routing functionality and VFR service router agent functionality (defined below). The term “router” refers to a device that includes layer 3 routing functionality but that does not necessarily include VFR service router agent functionality. A router becomes a service router when VFR service router agent functionality is added to the router.

VFR proxy forwarder devices may utilize virtual IP addressing concepts described by VRRP allowing for simple and shared routing configurations to be deployed on participating devices.

Although a VFR enabled device can coexist with routing protocols allowing routed packets to transit through a layer 2 domain, the VFR service is best suited for edge routing scenarios typically used in enterprise networks and datacenters that require routing, including configuration using multiple VLANs.

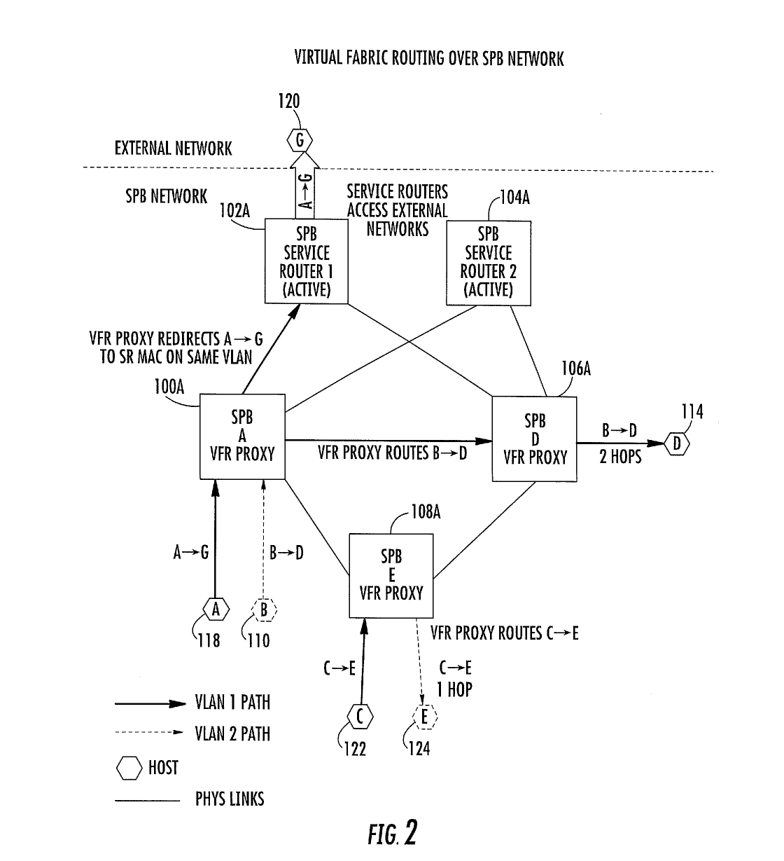

FIG. 2 shows VFR proxy forwarder devices enabled on the layer 2 nodes using SPB as the layer 2 service. In FIG. 2, nodes 100A, 106A, and 108A are VFR proxy forwarder devices that perform single hop layer 3 routing between VLANS within the VFR domain on behalf of one or more service routers 102A and 104A and redirect packets to one of service routers 102A and 104A for destinations that VFR proxy forwarders 100A, 106A, and 108A cannot resolve (cannot forward based on lack of knowledge of the destination). Service routers 102A and 104A are border routers that are integrated layer 2 nodes and that have full router capability. The existence of routers 102A and 104A may be advertised by the layer 2 topology protocol to denote external routing capabilities i.e., that service routers 102A or 104A can be the default routes for packets that are not routable by VFR proxy forwarder devices 100A, 106A, and 108A. VFR proxy forwarder devices 100A, 106A, and 108A may discover routers 102A and 104A through a layer 2 protocol field, through a field of another OSI layer, through proprietary messaging, or static configuration. This enables proxy forwarders 100A, 106A, and 108A to maintain a table of available routers and their corresponding MAC addresses and thereby support router redundancy directly without the need for the VRRP on each VLAN. As will be described in detail below, in one embodiment, a VFR service router agent may communicate the layer 2 address of the service router to the VFR proxy forwarders.

Furthermore, the routing capabilities information that is carried by the layer 2 topology or other protocol may contain a priority field allowing VFR proxy forwarders 100A, 106A, and 108A to consider when selecting a router MAC in the forwarding plane. In the SPBV example above, the layer 2 topology protocol used to carry the router capabilities is intermediate system to intermediate system (IS-IS) which supports the parameters for the router.

Virtual fabric routing differs from traditional routing configurations in that VFR proxy forwarders 100A, 106A, and 108A run a layer 2 topology protocol and may have the exact same router interface configuration to each VLAN on each device. Traditional routing setups require each interface on each router to have a different IP address, an active redundancy protocol like VRRP, and/or static route configuration, and/or L3 topology protocols like open shortest path first (OSPF).

In FIG. 2, when packets from host B 110 that are layer 3 addressed to destination D 114 on VLAN 2 are received by VFR proxy forwarder device 100A, VFR proxy forwarder device 100A, rather than automatically forwarding the packets to service router 102A, performs a layer 3 address lookup for the packets. Because destination D 114 is reachable through VFR proxy forwarder device 106A, which is directly connected to VFR proxy forwarder device 100A, the address lookup resolves to destination D 114, and VFR proxy forwarder device 100A forwards the packets to VFR proxy forwarder device 106A on VLAN 1, which is different from VLAN 2 on which the packets were received. Thus, in addition to performing the layer 3 address lookup, VFR proxy forwarder device 100A performs VLAN switching for packets addressed to hosts whose next hops are within the VFR forwarding domain. VFR proxy 106A receives the packets from VFR proxy forwarder device 100A on VLAN 1 and performs a layer 2 MAC bridging operation to forward the packets to destination D 114 on the same VLAN, VLAN 1.

The packets from host B 110 to host D 114 traverse 2 hops (one layer 3 router hop and one layer 2 bridging hop) using VFR forwarding. This can be contrasted with the example in FIG. 1, where the packets from host B to host D traverse 3 hops (a layer 2 bridging hop, followed by a layer 3 router hop, followed by a layer 2 bridging hop).

In another example, when host A 118 sends packets on VLAN 122 to VFR proxy forwarder device 100A that are layer 3 addressed to destination G 120, VFR proxy forwarder device 100A attempts to perform a layer 3 address lookup and determines that it does not have a layer 3 address provisioned for destination G. Accordingly, VFR proxy forwarder device 100A forwards the packets to service router 102A on the same VLAN, VLAN 1. Service router 102A performs a layer 3 address lookup for the packets, resolves the IP address of the packets, and forwards the packets to destination G 120 The operations performed by VFR proxy forwarder device 100A in forwarding packets whose IP addresses cannot be resolved to service router 102A is different from the forwarding mechanism illustrated in FIG. 1. In FIG. 1, all packets requiring layer 3 address lookups were forwarded to one of the service routers. In FIG. 2, only packets whose IP addresses cannot be resolved by VFR proxy 100A are sent to service router 102A. The mechanism for sending the packets to service router 102A is a redirection to the service router MAC address on the same VLAN.

In another routing example, packets leaving host C 122 that are layer 3 addressed to host E 124 only go through a single hop in the network because VFR proxy 108A performs the layer 3 address lookup for the packets and forwards the packets from host C to host E. This can be contrasted with the traditional case illustrated in FIG. 1 where such packets traverse 5 hops in the network.

It should be noted that for packets entering the VFR domain from outside of the VFR domain, the first hop will be a layer 3 router hop (either to a router, a VFR proxy, or to a destination host (as in the C-E case above). In the SPB network illustrated in FIG. 1, the first hop for packets from outside of the VFR domain is a layer 2 bridging hop, either to a router or another node in the SPB domain.

Another difference between the architectures illustrated in FIG. 1 and FIG. 2 is that in FIG. 1, traditional routers 102 and 104 function in an active standby configuration and in FIG. 2, routers 102A and 104A function in an active-active configuration. As such, routers 102A and 104A are not required to run VRRP or other router redundancy protocol, which reduces the processing burden on routers 102A and 104A.

The following are exemplary features of the subject matter described herein. However, the subject matter described herein is not limited to a device, system, or method that includes any combination of these features.

(1) Concept of VFR Proxy Forwarding
Virtual Fabric Routing is a concept that supports the establishment of a network-wide, distributed virtual routing system. Packet forwarding nodes in the VFR system support layer 3 forwarding using the VFR proxy and work as a single collective forwarding mechanism. VFR proxy forwarder devices serve on behalf of service routers by performing single hop layer 3 routing of packets between the VLANs and layer 2 forwarding (MAC bridging) within the layer 2 connected domain, thereby utilizing the most efficient path through the network.

(2) Common Routing Interface Configuration
In one exemplary implementation, the layer 2 fabric ensures every VLAN exists on every node within the VFR forwarding domain. Having a common routing interface configuration can be achieved using the same set of configuration commands or common file which can be copied to all VFR proxy forwarder devices, or installed via management systems using simple network management protocol (SNMP) management information bases (MIBS), extensible markup language (XML) schema, or distributed by standard or private protocols including private extensions to standard protocols. Benefits of deploying a common routing interface configuration on all VFR proxy forwarding devices are reductions in administrative burden, faster deployment and decreased configuration errors compared to those typically found in traditional routed networks. It is possible that software defined networks (SDN) or L3 protocols, like border gateway protocol (BGP), may distribute the configuration and/or common forwarding table. In such environments, it may result in little or no configuration on the VFR proxy forwarder devices. Further, it is possible to make a change in a single device and allow that change to propagate via existing or new protocols to each VFR proxy forwarder device, ensuring network consistency.

(3) Discovery of Router MAC Addresses
By default, VFR proxy forwarding will be present on all layer 2 edge devices (i.e., the VFR proxy forwarder devices) within the VFR domain. The distributed forwarding plane of VFR proxy forwarder devices knows the set of service routers for use when they cannot resolve the destination IP address. Packets are then forwarded to one of the eligible service router's MAC addresses attached to the layer 2 domain. In one exemplary implementation, the VFR proxy forwarder devices utilize a default MAC address to forward unresolvable L3 packets to the service router. The border router MACs serving as the service routers can be provisioned statically or learned dynamically. One aspect of the subject matter described herein includes carrying router capabilities and priority in the layer 2 protocol to support router redundancy. For example, SPB uses the IS-IS protocol to form the layer 2 topology, allowing router capabilities to be carried as type-length-value (TLVs) in LSP advertisements. For IS-IS protocol capable nodes that advertise router capabilities, it is their MACs that are considered as qualified routers. VFR proxy forwarder devices, also IS-IS protocol capable nodes, may learn the set of routers carrying these TLVs and manage the list of service router MAC addresses that are available. Based on this list of service routers and attributes, the VFR proxy forwarder devices may use router priority and/or topology node metrics to determine to which router MAC address to forward unresolvable host packets. Both router redundancy and load balancing are possible via this single mechanism. The topology protocol informs VFR proxy forwarder devices when a router node joins or leaves the network, giving the ability for VFR proxy forwarder devices to properly manage their service router set.

(4) Virtualized Default Gateways to Support Mobility of Users, Hosts, Clients, and Servers within the Switch Fabric Domain.
VFR proxy forwarder devices act as default gateways for hosts on VLANS recognized within the VFR forwarding domain without using layer 3 protocols or redundancy election protocols. VFR proxy forwarder devices install a virtual MAC in the layer 2 address table in order to receive and forward packets destined for the default gateway. The virtual MAC is not be propagated as a source MAC by a VFR proxy forwarder device within the layer 2 domain. Although any layer 2 topology protocol may work, in one exemplary implementation, only a single VFR proxy forwarder receives packets to be forwarded to a given host. SPB ensures this behavior while certain basic spanning environments may not.

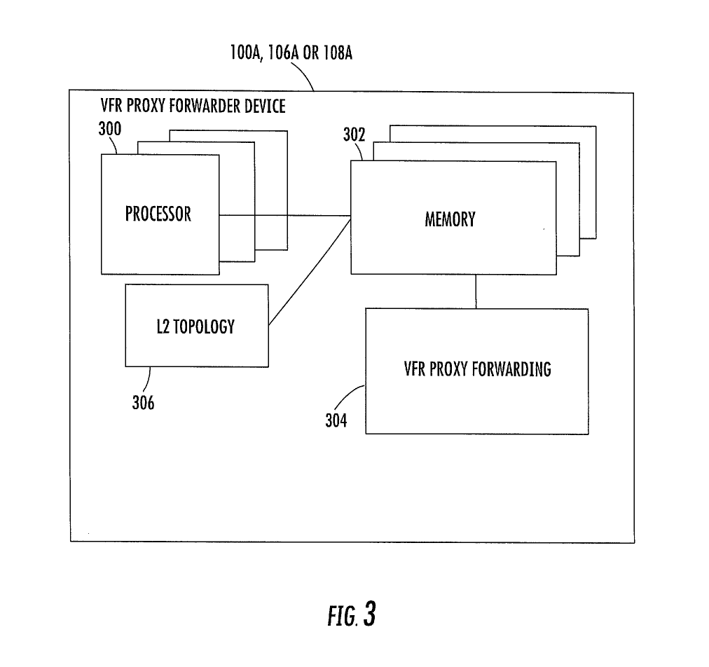

(5) Eliminate Layer 3 Routing Protocols
Since Layer 2 protocols can build a multipath topology domain, in one exemplary implementation, there is no need to form layer 3 routing topologies within the same layer 2 forwarding domain. VFR proxy forwarders leverage the multipath L2 topology as hosts within the layer 2 domain are no further than 1 routing hop away. Furthermore, in one exemplary implementation, there is no need to have router redundancy protocols like VRRP as the edge VFR proxy forwarder, with help from the service routers, serves that purpose. That is, router redundancy may be provided by using layer 2 topology protocols that carry added information about router capabilities. FIG. 3 is a block diagram illustrating exemplary architecture for a VFR proxy forwarder device according to an embodiment of the subject matter described herein. Referring to FIG. 3, VFR proxy forwarder device 100A, 106A, or 108A includes at least one processor 300 and at least one associated memory 302. VFR proxy forwarder device 100A, 106A, or 108A further includes a VFR proxy forwarding module 304 executed by or embodied in processor(s) 300 for performing the operations described herein for VFR proxy forwarding. These operations include performing layer 3 routing on behalf of a service router for packets traversing VLANs and addressed to nodes within the virtual fabric routing domain and for layer 2 forwarding, to the layer 2 address of a service router, packets for which a layer 3 address resolution fails. In addition, the VFR Proxy forwarding module performs the layer 2 forwarding of packets (typically IEEE 802 MAC Bridging) with each VLAN. The layer 3 routing information used by the VFR proxy forwarding module 304 may be statically or semi statically configured wholly or in part or learned by the VFR proxy forwarding module 304 using a layer 2 or layer 3 topology discovery protocol or a protocol separate from a topology discovery protocol. The L3 routing information for a given VFR proxy forwarding device may include layer 3 forwarding information for all or a subset of nodes within the VFR domain. In one example, the L3 routing information for a given VFR proxy forwarder device may include layer 3 forwarding information for nodes within a single routing hop of the VFR proxy forwarder device.

In the illustrated example, the VFR proxy forwarder further includes a layer 2 topology protocol module 306, such as SPB, to build the underlying layer 2 topology. The L2 topology protocol module 306 may utilize a layer 2 topology discovery protocol, such as IS-IS, to learn the MAC address of the service router. This module also may contain the L2 forwarding database (FDB).

In one embodiment, the VFR proxy forwarding module 304 may use an extension to IS-IS to learn the MAC and/or IP address of the service router. For example, the service router agent may insert its VFR capabilities information into an IS-IS LSP-0 message as experimental TLV 250 and send the message to VFR proxy forwarder devices in the layer 2 domain. The TLV may be present with the virtual fabric routing flag set to not-in-service or the TLV may be not present at all. The case where TLV is present but the VFR flag is set to not-in-service may be used when the feature is de-configured and sent for a period of several (perhaps three) LSP refresh intervals. Table 1 below illustrates exemplary fields that may be included in TLV 250 to support VFR. Table 2 illustrates exemplary flag bits for the flag field of TLV 250 to support VFR. Table 3 illustrates values for non-reserved flag bits to support VFR.

TABLE 1
TLV 250 Fields to Support VFR

| Byte | Field Description (default value) |
|---|---|
| 1 | IS-IS Experimental TLV (250) |
| 2 | Length (11) |
| 3-5 | Enterasys/Extreme OUI (0x00001D) |
| 6 | RaaS subtype (1) |
| 7 | Length (6) |
| 8 | Flags (1) |
| 9 | Priority (100) |
| 10-13 | Unique IPv4 Router ID (0) is valid |
| 14-33 | Unique IPv6 address |

TABLE 2
Flag Bits for Flag Field in TLV 250 to Support VFR

| 0 | 1 | 2 | 3 | 4 | 5 | 6 | 7 |
|---|---|---|---|---|---|---|---|
| R | R | R | R | R | N | V | I |

TABLE 3
Values for Flag Bits

| Bit | Description (default) |
|---|---|
| 0 | Reserved (0) |
| 1 | Reserved (0) |
| 2 | Reserved (0) |
| 3 | Reserved (0) |
| 4 | Reserved (0) |
| 5 | N (0) - Not Inservice, 1 not in service, 0 in service |
| 6 | V (0) - IPV6 Address, 1 is present, 0 not present |
| 7 | I (1) - IPV4 Address, 1 is present, 0 not present |

In Table 3, if bit 5 of the flag bits for TLV 250 is set to “in service”, and bit 6 is set to “IPv6 address is present”, then the receiving VFR proxy forwarder device 100A, 106A, or 108A knows that the IS-IS experimental TLV 250 contains an IPv6 address. The IPv6 address will be carried in bytes 14-33 of the IS-IS experimental TLV 250. When VFR proxy forwarder device 100A, 106A, or 108A receives such an IS-IS TLV, the receiving VFR proxy forwarder device 100A, 106A, or 108A updates its layer 3 address table to associate the IPv6 address of the service router with the router default MAC address, which may be statically configured within VFR proxy forwarder 100A, 106A, or 108A.

### Gratuitous ARP on Service Routers

To avoid flooding of unknown MAC addresses from downstream VFR proxy forwarder devices within the VFR network or domain, service routers may periodically send gratuitous ARP requests to VFR proxy forwarder devices to keep the MAC addresses of the service routers in the filter databases, which hold learned MAC addresses along with the physical port on which the addresses are learned. Without such gratuitous ARP requests, the MAC addresses used by the routers for ARP messages and maintained by the VFR proxy forwarder devices would age out and be deleted. Unwanted flooding can occur as a result of the age out.

The gratuitous ARP requests may be sent on VFR facing interfaces only to maintain their MAC address with downstream forwarding devices. The interval between the gratuitous ARP requests may be synchronized with FDB age-out timers minus a predetermined time period designed to ensure that the MAC router address is updated in each VFR proxy forwarder device before the age-out timer expires. The interval may update after the next timer fires on any change to FDB age-out and may cease when VFR is disabled. In addition, unicast ARP requests may be sent to the service router's router-id by the VFR proxy forwarder devices when the service router's FDB entry is not found. These are efforts to maintain a service router's MAC address in the forwarding database of each VFR proxy forwarder per VLAN ID (VID) and avoid flooding of unknown MACs commonly found in asymmetrical routing scenarios.

### VFR Proxy Forwarder Processing of TLV 250

In one implementation of the subject matter described herein, a VFR proxy forwarder device may invoke a process, referred to as a “custom user exit” when another VFR proxy forwarder device joins or leaves the VFR topology.

The IS-IS LSP-0 or LSP-1 message with TLV 250 will be received by the VFR proxy forwarders. IS-IS running on the VFR proxy forwarder device may call the custom user exit to decode the TLV. The service router information is passed along to the L3 forwarding element of the VFR proxy forwarder device using an “Update” call. (Action, Router-ID, SYSID (MAC))

Action—0 is delete, 1 is update (new or changed).
Router-id must be present and unique throughout the SPB network.

The VFR proxy forwarder device obtains the router MAC address from the SYSID of the node obtained from TLV 250 and may be the same for all VLAN interfaces.

The custom user exit may be called with the delete action if the TLV is no longer present or the not-in-service flag is set. The SPB code may store a VFR status flag for each SYSID to speed up the processing and to know when to make the user exit call.

The subject matter described herein is not limited to using the layer 2 topology discovery protocol to communicate the service router MAC address to the VFR proxy forwarders. In an alternate embodiment, an existing or new (e.g., a proprietary protocol) may be used to communicate the service router MAC address to the VFR proxy forwarder devices. In yet another alternate embodiment, the VFR proxy forwarders may be configured with the MAC address of the service router.

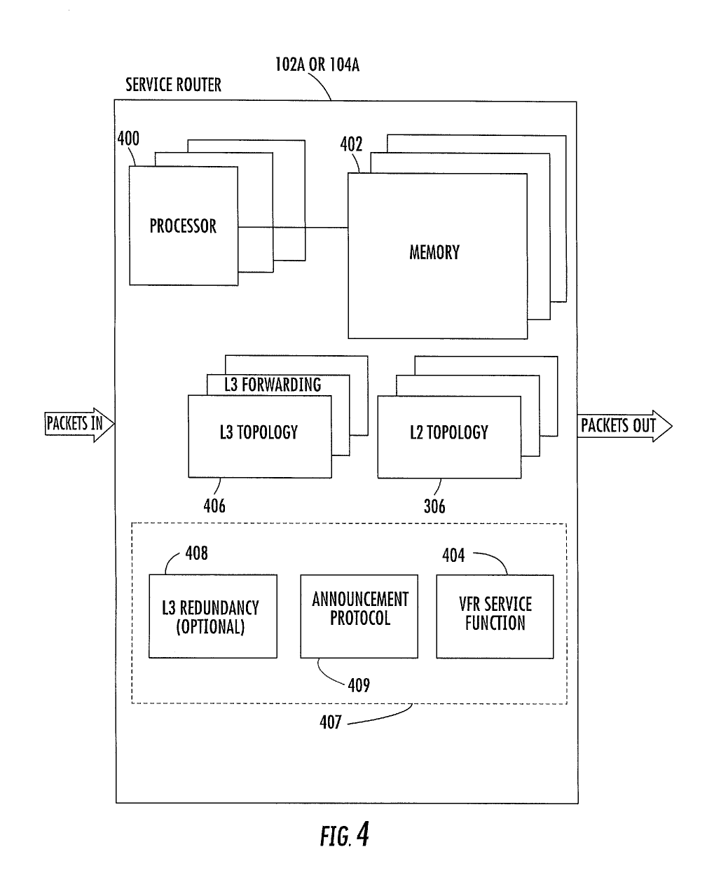

FIG. 4 is a block diagram of a service router 102A or 104A according to an embodiment of the subject matter described herein. In FIG. 4, service router 102A or 104A includes at least one processor 400 and at least one associated memory 402. Service router 102A or 104A includes a routing module 406 that routes IP packets whose IP addresses were unresolvable by VFR proxy forwarders. Service router 102A or 104A also includes an L3 topology protocol module 406, that implements a L3 topology protocol, such as border gateway protocol (BGP), open shortest path first (OSPF), or routing information protocol (RIP), to build and maintain its layer 3 route table. As stated above, a service router is a layer 3 router with a VFR service router agent. Accordingly, service router 102A or 104A includes a VFR service router agent 407. VFR service router agent 407 may include a layer 3 redundancy protocol module 408, which may implement a layer 3 redundancy method agent 407, if aware of alternate paths or redundant active paths may announce that information in the announce messages to the VFR proxy forwarding devices. The alternate paths or redundant active paths may be learned via several mechanisms including: existing protocols, proprietary protocols, manual and automatic configuration and knowledge based on the functions incorporated with VFR service router agent 407. Generally module 408 provides alternate path information to announcement module 409 which sends that information to the VFR proxy forwarding devices.

Service router 102A or 104A may also include a layer 2 topology protocol module 306 that runs the same layer 2 topology protocol as the VFR proxy forwarder devices so that service router 102A or 104A can learn the topology of the layer 2 domain. This module may also contain the L2 forwarding database (FDB). Service router 102A or 104A may use the IS-IS extension described above or any of the alternate mechanisms described herein to communicate its MAC address and VFR service capabilities to the VFR proxy forwarder devices.

VFR service router agent 407 provides access to layer 3 routing services of service router 102A or 104A by making the MAC address of service router 102A or 104A available to the VFR proxy forwarders. VFR service router agent 407 may make the MAC address available to the VFR proxy forwarders in any suitable manner, such as a layer 2 topology discovery protocol.

Although in the illustrated example VFR service router agent 407 is a component of service router 102A or 104A, the subject matter described herein is not limited to such an embodiment. VFR service router agent 407 may operate on a device, such as a computing platform having a processor and a memory that is separate from a layer 3 router. The term “VFR service router agent device” is used herein to refer generally to the device on which the VFR service router agent executes, whether the device is a router, another network node, or server device.

VFR service router agent 407 includes the above-mentioned layer 3 redundancy protocol module 408 (which is optional) and announcement protocol module 409 that announces the router's MAC address (received from module 404 to VFR proxy forwarder devices. This is typically done by providing the layer 2 address of the layer 3 router's interface in an announcement protocol, including, but not limited to the aforementioned layer 2 topology discovery protocol. Proprietary or extensible protocols (such as IS-IS) or manual operations may be used to provide the interface information to the VFR proxy forwarder devices. VFR service router agent 407 further includes VFR service function 404. VFR service function 404 identifies an interface to the router providing layer 3 services for the VFR domain. Overall, VFR service router agent 407 comprises a facility or software that embodies some or all of components 404, 408 and 409. These components can be added to a traditional router to create a service router. Alternatively, VFR service router agent 407 may be added in part or in whole to other devices of the network system.

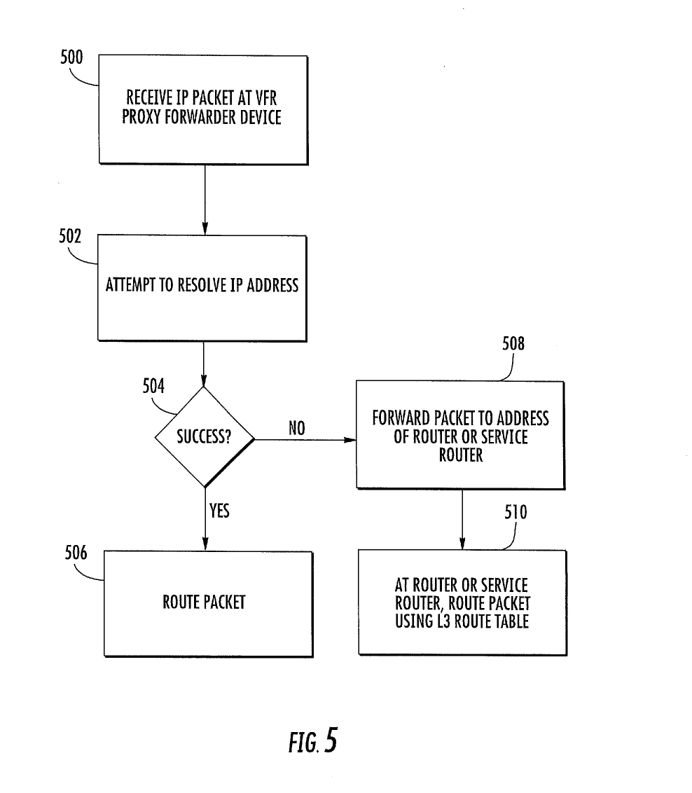

FIG. 5 is a flow chart illustrating an exemplary process for virtual fabric routing according to an embodiment of the subject matter described herein. Referring to FIG. 5, in step 500, an IP packet is received at a VFR proxy forwarder device. For example, an IP packet may be received at VFR proxy forwarder 100A illustrated in FIG. 2. In step 502, the VFR proxy forwarder device attempts to resolve the IP address using its layer 3 route information. For example, VFR proxy forwarder device 100A may perform a lookup in its layer 3 route table to attempt to resolve the destination IP address in the packet. In step 504, it is determined whether the resolution is successful. If the resolution is successful, control proceeds to step 506 where the packet is layer 3 routed (proxy router forwarding path). If the resolution is not successful, control proceeds to step 508 where the packet is forwarded to the address of a router or a service router. In one embodiment, the address may be a layer 2 address of the service router provided by a VFR service router agent, and the packet may be modified to include the layer 2 address. Modifying the packet for forwarding to the layer 2 address of the router or service router may include leaving the source layer 2 address in the packet unchanged, leaving the layer 3 header in the packet unchanged, and replacing the destination layer 2 (MAC) address with the layer 2 (MAC) address of the router or service router. Once the destination layer 2 address in the packet is replaced with the layer 2 address of the router or service router, the packet is forwarded to the VFR service router. Intervening hops in the VFR domain will be layer 2 forwarded to the router or service router. In step 510, the router or service router resolves the layer 3 address in the packet using its layer 3 route table and forwards the packet (traditional routing path).

The example illustrated in FIG. 5 assumes that the packet received by the VFR proxy forwarder device is an IP packet for which the VFR proxy forwarder device is to attempt a layer 3 routing address resolution using the destination IP address in the packet. Such a packet would typically be layer 2 addressed to a layer 2 address of the VFR proxy forwarder device. If the packet received by the VFR proxy forwarder device is instead addressed to a layer 2 address that is not the layer 2 address of the receiving VFR proxy forwarder device, the receiving VFR proxy forwarder device performs a lookup in its layer 2 forwarding database based on the destination layer 2 address in the packet. If a match is located, the packet is layer 2 forwarded (bridged) to next hop layer 2 node in the VFR domain corresponding to the layer 2 address in the packet.

VFR proxy forwarding improves the technological fields of layer 2 and layer 3 packet forwarding by reducing latency when routing within VFR domain. L3 forwarding tables of the VFR proxy forwarder devices are smaller than traditional routers would need in the same size network. The L3 forwarding tables in the VFR proxy forwarding devices need not include forwarding table entries for devices or networks outside of the VFR domain. Configuration is greatly lessened over traditional networks, as the VFR proxy forwarders may have identical routing configurations for each interface. VLAN forwarding within the VFR domain is easier than in the traditional network (see FIG. 1) because, in the VFR domain, the task of VLAN forwarding is distributed to all or a subset of the VFR proxy forwarder devices. As a result, latency is reduced. Thus, a VFR proxy forwarder device or a service router configured for VFR proxy service routing constitutes a special purpose computing device that improves the technological fields of layer 2 and layer 3 packet forwarding.

One advantage of the VFR forwarding function being distributed throughout the layer 2 or VFR domain is that such distribution improves overall path costs when compared with traditional routing approaches. By directly forwarding from the VFR proxy forwarder devices, the sum of link metrics in the possible forwarding paths in the VFR domain will never be greater than the traditional approach. Furthermore, the sum of all path costs from all client hosts to every other client host will have lower aggregate path cost when the number of client hosts is greater than the number of bridge nodes in the network. This lower path cost will result in equal or lower latency than in the corresponding traditional topology where a one-armed router is used (see FIG. 1).

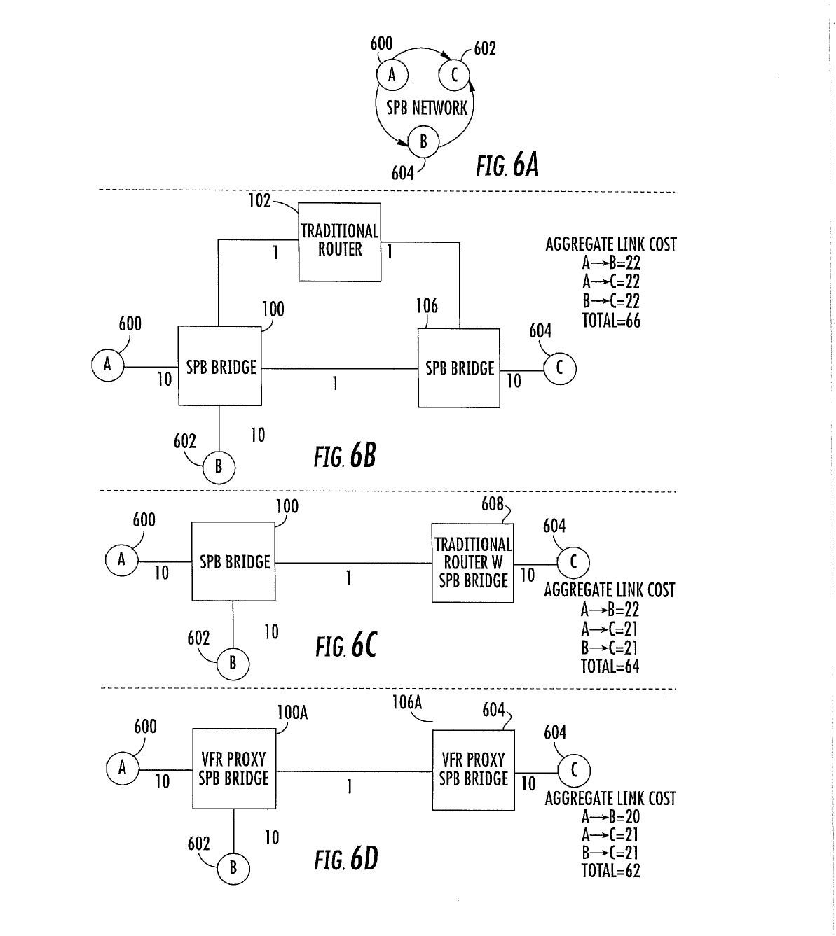

FIGS. 6A-6D illustrate routing methods over a shortest path bridging network and associated link costs. In FIG. 6A, 3 hosts 600, 602, and 604 reside on unique VLANS and therefore require L3 forwarding to each other. As illustrated in FIG. 6B, hosts 600, 602, and 604 are connected to each other via SPB nodes 100 and 106 and traditional router 102. Each link interconnecting the nodes and hosts illustrated in FIG. 6B may be assigned a cost, for example, based on the bandwidth of the link. In the illustrated example, the cost on the link between a host and an SPB node is 10, and the cost between the SPB node and router 102 is 1. Because routing is required to send messages between different VLANs, packets leaving host A 600 destined for host C 604 must go from host A 600, to SPB bridge 100, to router 102, to SPB bridge 106, and from SPB bridge 106 to host C 604, for a total cost of 22. The costs of routing from host A 600 to host B 602 and from host B 602 to host C 604 is also 22. Adding the link costs for routing between nodes, the total for the network illustrated in FIG. 6B is 66.

FIG. 6C illustrates an example where SPB bridge 106 and traditional router 102 are combined into a single node 608. In such an example, packets from host A 600 to host B 602 must still go through router 608 for a link cost of 22. Packets from host A 600 to host C 604 go through SPB bridge 100 and router 608 for a total link cost of 21. Similarly, packets from host A 600 to host C 604 go from SPB bridge 100, through router 608, and to host C 604, for a total cost of 21. The aggregate link cost of routing in FIG. 6C is 64.

FIG. 6D illustrates link costs using virtual fabric routing according to an embodiment of the subject matter described herein. In FIG. 6D, because each VFR proxy forwarder device 100A and 106A can route packets to nodes that are directly connected to another VFR proxy forwarder device, including switching VLANs, the path to a service router and back from the service router is eliminated, resulting in reduced aggregate link costs. For example, in the network illustrated in FIG. 6C, packets from host A 600 to host B 602 traverse only VFR proxy forwarder device 100A, which performs the layer 3 route lookup and routes the packets from host A 600 to host B 602, with a total link cost of 20. Packets from host A 600 to host C 604 are routed by VFR proxy forwarder device 100A to VFR proxy forwarder device 106A. VFR proxy forwarder device 106A layer 2 forwards the packets to host C 604, for a total link cost of 21. Packets from host B 602 to host C 604 are routed by VFR proxy forwarder device 100A to VFR proxy forwarder device 106A. VFR proxy forwarder device 106A layer 2 forwards the packets to host C 604. The total aggregate link cost for forwarding between the hosts in FIG. 6D is 62, which is lower than the total aggregate cost for the examples illustrated in FIG. 6B or 6C, thus illustrating yet another example of VFR proxy forwarding as described herein. In addition to the path cost analysis, the processing requirements are less when using L2 forwarding instead of the L3 forwarding. Further, the limited L3 forwarding of the VFR L3 capabilities is faster than a traditional router. This can lead to better CPU performance, lower cost and lower forwarding latency.

It will be understood that various details of the presently disclosed subject matter may be changed without departing from the scope of the presently disclosed subject matter. Furthermore, the foregoing description is for the purpose of illustration only, and not for the purpose of limitation.

1. A system for virtual fabric routing, the system comprising:
a virtual fabric routing (VFR) service router agent for providing access to layer 3 routing; and
at least one VFR proxy forwarder device, for performing layer 3 routing for packets traversing virtual local area networks (VLANs) within a virtual fabric routing domain and for forwarding, to an address of a router provided by the VFR service router agent, packets for which a layer 3 address resolution fails.

2. The system of claim 1 wherein the VFR service router agent provides access to layer 3 routing by providing the address of the router to the VFR proxy forwarder device.

3. The system of claim 2 wherein the address comprises a layer 2 address.

4. The system of claim 3 wherein the layer 2 address comprises a medium access control (MAC) address.

5. The system of claim 1 wherein the at least one VFR proxy forwarder device includes a layer 2 topology protocol module.

6. The system of claim 5 wherein the layer 2 topology protocol module receives the address of the router from the VFR service router agent using a layer 2 topology protocol.

7. The system of claim 6 wherein the layer 2 topology protocol comprises a bridging protocol.

8. The system of claim 7 wherein the bridging protocol comprises a spanning tree protocol (STP).

9. The system of claim 7 wherein the bridging protocol comprises a shortest path bridging (SPB) protocol.

10. The system of claim 5 wherein the layer 2 topology protocol comprises an IEEE 802 compliant protocol.

11. The system of claim 3 wherein the VFR service router agent utilizes a protocol different from a layer 2 topology protocol to communicate, to the VFR proxy forwarder device, the layer 2 address used for the forwarding to the router.

12. The system of claim 3 wherein, for each packet for which layer 3 address resolution fails, the VFR proxy forwarder device is configured to forward the packet to the layer 2 address of the router without modifying of a layer 2 source address, a VLAN, and a layer 3 header of the packet.

13. The system of claim 1 wherein the VFR proxy forwarder device comprises a plurality of VFR proxy forwarder devices, each VFR proxy forwarder device having a common routing interface configuration.

14. The system of claim 1 wherein the VFR proxy forwarder device includes a packet forwarding database populated with information for the single hop layer 3 routing within the VFR domain without participating in layer 3 redundancy protocols.

15. The system of claim 1 wherein the VFR proxy forwarder device comprises a plurality of VFR proxy forwarder devices that distribute forwarding between VLANs within the VFR domain.

16. The system of claim 1 wherein the VFR proxy forwarder device performs layer 2 bridging within the VFR domain for packets whose ingress and egress VLANs are the same.

17. The system of claim 1 wherein the router comprises a VFR service router on which the VFR service router agent resides.

18. The system of claim 1 wherein the router comprises a router separate from a computing platform on which the VFR service router agent resides.

19. A virtual fabric routing (VFR) proxy forwarder device comprising:
at least one processor;
a VFR proxy forwarding module executable by or embodied in the at least one processor for performing layer 3 routing for packets traversing virtual local area networks (VLANs) within a virtual fabric routing domain and for forwarding, to an address of router, packets for which a layer 3 address resolution fails.

20. The VFR proxy forwarder device of claim 19 wherein the address comprises a layer 2 address.

21. The VFR proxy forwarder device of claim 20 wherein the layer 2 address comprises a medium access control (MAC) address.

22. The VFR proxy forwarder device of claim 20 comprising a layer 2 topology protocol module.

23. The VFR proxy forwarder device of claim 22 wherein the layer 2 topology protocol module is configured to receive, from a VFR service router agent, the layer 2 address of the router using a layer 2 topology protocol.

24. The VFR proxy forwarder device of claim 23 wherein the layer 2 topology protocol comprises a bridging protocol.

25. The VFR proxy forwarder device of claim 24 wherein the bridging protocol comprises a spanning tree protocol (STP).

26. The VFR proxy forwarder device of claim 24 wherein the bridging protocol comprises a shortest path bridging (SPB) protocol.

27. The VFR proxy forwarder device of claim 20 wherein the VFR proxy forwarding module utilizes a protocol different from a layer 2 topology protocol to receive, from a VFR service router agent, the layer 2 address of the a router usable by the VFR proxy forwarder device for the forwarding to the router.

28. The VFR proxy forwarder device of claim 20 wherein the layer 2 address of the router usable by the VFR proxy forwarder device for the forwarding to the router comprises a configuration option of the VFR proxy forwarder device.

29. The VFR proxy forwarder device of claim 20 wherein, for each packet for which layer 3 address resolution fails, the VFR proxy forwarding module is configured to forward the packet to the layer 2 address of the router without modifying at least one of a layer 2 source address, a VLAN address, and a layer 3 header of the packet.

30. The VFR proxy forwarder device of claim 19 comprising a routing interface configuration that is common with respect to other VFR proxy forwarder devices in the VFR forwarding domain.

31. The VFR proxy forwarder device of claim 19 comprising a forwarding database populated with information for the single hop layer 3 routing within the VFR domain without participating in layer 3 redundancy protocols.

32. The VFR proxy forwarder device of claim 19 wherein the VFR proxy forwarding module provides router redundancy without participating in a layer 3 redundancy protocol.

33. The VFR proxy forwarder device of claim 19 wherein the at least on VFR proxy forward device performs layer 2 bridging within the VFR domain for packets whose ingress and egress VLANs are the same.

34. The VFR proxy forwarder device of claim 19 wherein the router comprises a VFR service router on which a VFR service router agent resides.

35. The VFR proxy forwarder device of claim 19 wherein the router comprises a router without a VFR service router agent.

36. A virtual fabric routing (VFR) service router agent device providing access to layer 3 routing in a VFR domain, the service router comprising:
at least one processor; and
a VFR service router agent executable by or embodied in the at least one processor for providing access to layer 3 routing by advertising an address of a router to VFR proxy forwarder devices, wherein the router receives packets forwarded from the VFR proxy forwarder devices within a VFR domain for which the VFR proxy forwarder devices are unable to resolve layer 3 addresses, and performs layer 3 address resolution for the forwarded packets, and routes the packets based on results of the layer 3 address resolution.

37. The VFR service router agent device of claim 36 wherein the address comprises a layer 2 address.

38. The VFR service router agent device of claim 37 wherein VFR service router agent utilizes a layer 2 topology protocol to communicate, to the VFR proxy forwarder devices, the layer 2 address of the router.

39. The VFR service router agent device of claim 37 wherein the VFR service router agent utilizes a protocol different from a layer 2 topology protocol to communicate, to the VFR proxy forwarder devices, the layer 2 address of the router.

40. The VFR service router agent device of claim 37 wherein the layer 2 address of the router comprises a configuration option for at least some of the VFR proxy forwarder devices.

41. The VFR service router agent device of claim 36 wherein the router performs layer 3 address resolutions for packets received from outside of the VFR domain and forwards the packets to the VFR forwarder devices within the VFR domain.

42. A method for virtual fabric routing, the method comprising:
providing access to, by a virtual fabric routing (VFR) service router agent, layer 3 routing; and
performing, by at least one VFR proxy forwarder, layer 3 routing for packets traversing virtual local area networks (VLANs) within a virtual fabric routing domain and for forwarding, to an address provided by the VFR service router agent, packets for which a layer 3 address resolution fails.

43. A non-transitory computer readable medium having stored thereon executable instructions that when executed by the processor of a computer control the computer to perform steps comprising:
providing access to, by a virtual fabric routing (VFR) service router agent, layer 3 routing; and
performing, by at least one VFR proxy forwarder, layer 3 routing for packets traversing virtual local area networks (VLANs) within a virtual fabric routing domain and for forwarding, to an address provided by the VFR service router agent, packets for which a layer 3 address resolution fails.
